(19) United States
(12) Patent Application Publication
(10) Pub. No.: US 2008/0235519 A1
(43) Pub. Date: Sep. 25, 2008

(54) Data processing method and data processing device

(75) Inventors: Masafumi Onouchi, Hachioji (JP); Kenji Saito, Mitaka (JP)

Correspondence Address: Stanley P. Fisher;Reed Smith LLP, Suite 1400, 3110 Fairview Park Drive, Falls Church, VA, 22042-4503, US

(73) Assignees: Hitachi, Ltd.; Renesas Technology Corp.

(21) Appl. No.: 12/000,852

(22) Filed: Dec. 18, 2007

(30) Foreign Application Priority Data
Jan. 31, 2007 (JP) 2007-020791

(51) Int. Cl. G06F 9/00

(52) U.S. Cl. 713/189

(57) ABSTRACT

An object is to achieve improvement in efficiency in a case where encoding processing of data and encryption processing are executed in parallel with each other. A program of a first accelerator core out of multiple accelerator cores is reconfigured for encryption processing in order to perform encryption processing on encoded data. At this time, control is extended so that the time required for encoding processing of data for one frame and the total time of the program rewrite time for the first accelerator core and the time which the first accelerator core requires for implementing encryption processing of accumulated encoded data will be nearly equal to each other. The control is performed by a first general-purpose processor out of multiple general-purpose processors. By minimizing a wasted time during which hardware does not execute any arithmetic and logic operation, improvement in efficiency in a case where encoding processing of data and encryption processing are executed in parallel with each other is achieved.

### CLAIM OF PRIORITY

The present application claims priority from Japanese application JP 2007-020791 filed on Jan. 31, 2007, the content of which is hereby incorporated by reference into this application.

### FIELD OF THE INVENTION

The present invention relates to a data processing technology, or more particularly, to a technology effectively applied to a data processing device that enables, for example, encoding processing of audio data and encryption processing of encoded audio data.

### BACKGROUND OF THE INVENTION

Conventionally, a speeding-up technology that employs dedicated hardware (refer to, for example, patent documents 1 and 2) and a priority determination technology for an encoding task (refer to, for example, a patent document 3) are known as technologies for implementing at a high speed encoding processing of audio data and encryption processing of encoded audio data.

Owing to a recent advancement in digital technologies, when video data or music data is encoded and preserved as digital data, high-definition video or audio can be enjoyed without any concern about degradation in data due to a time-sequential change in a recording medium. In particular, the MPEG-2 Audio Advanced Audio Coding (MPEG-2 AAC) (hereinafter, simply, the AAC) that realizes high audio quality and a high encoding ratio has prevailed more thoroughly than the MPEG Audio Layer-3 (MP3) that has been adopted as a music data encoding method in the past does. Consequently, high-quality music can be enjoyed through navigation for automobiles or cellular telephony.

In digital technologies, copyright protection counts. When music data is preserved as digital data, if the data is copied, the same music can be easily duplicated without degradation. In order to prevent such an incident, music data having undergone encoding processing is subjected to encryption processing so that it can be reproduced by specific music reproduction equipment alone. Thus, in future multimedia applications, speeding up of not only audio data encoding processing under the ACC but also encryption processing of encoded audio data will be a significant subject.

For the subject, in a system-on-a-chip (SoC) including a system LSI intended for conventional car navigation and cellular telephony, a dedicated digital signal processor (DSP) is used in combination with a general-purpose processor in order to realize speeding up of processing (refer to the patent documents 1 and 2). In the technologies, the dedicated DSP that implements encoding processing, a dedicated circuit that implements encryption processing, and the general-purpose processor that controls an entire system are used in combination so that the encoding processing and encryption processing will be sequentially implemented.

In a recent SoC, it is a matter of common practice to incorporate multiple general-purpose processors and multiple programmable accelerator cores (refer to, for example, a patent document 4).

[Patent document 1] Japanese Unexamined Patent Publication No. 2004-172775,
[Patent document 2] Japanese Unexamined Patent Publication No. 2004-199785
[Patent document 3] Japanese Unexamined Patent Publication No. 2005-316716
[Patent document 4] Japanese Unexamined Patent Publication No. 2006-287675.

### SUMMARY OF THE INVENTION

As mentioned above, in the recent SoC, it is a matter of common practice to incorporate multiple general-purpose processors and multiple programmable accelerator cores. Therefore, for effective utilization of the hardware resources, a technique for implementing the aforesaid AAC audio encoding processing and encryption processing in parallel with each other is indispensable.

The present inventor has studied a technique for executing AAC encoding processing of audio data and encryption processing of encoded audio data in parallel with each other by employing multiple general-purpose processors and multiple programmable accelerator cores. In order to execute the two pieces of processing at a high speed, a wasted time during which hardware does not execute any operation has to be reduced. However, the encoding processing of audio data is executed per a unit called a frame, a variable bit rate method in which a different bit rate is adapted to each frame is often employed in order to execute AAC encoding processing by efficiently utilizing a limited amount of data. Therefore, an amount of data that has undergone encoding processing and is assigned to one frame depends largely on requested audio quality or music data serving as a source. Consequently, when encryption processing of encoded audio data is executed in units of a predetermined number of frames, the time required for the encryption processing varies greatly. That's why the wasted time increases.

An object of the present invention is to achieve improvement in efficiency in a case where encoding processing of data and encryption processing are executed in parallel with each other.

The above object of the present invention, the other objects thereof, and the novel features thereof will be apparent from the description in the present specification and appended drawings.

Among inventions disclosed in the present application, a typical one will be briefed below.

Specifically, when a program of a first accelerator core out of multiple accelerator cores is reconfigured for encryption processing in order to perform encryption processing on encoded data, a first general-purpose processor controls an amount of encoded data so that the time required for encoding processing of data for one frame, and the total time of the program rewrite time for the first accelerator core and the time which the first accelerator core requires for implementing encryption processing of accumulated encoded data will be nearly equal to each other. Owing to the control, a wasted time during which hardware does not execute any operation is minimized.

An advantage to be provided by the typical one of the inventions disclosed in the present application will be briefed below.

Specifically, improvement in efficiency in a case where encoding processing of audio data and encryption processing are executed in parallel with each other can be achieved.

### BRIEF DESCRIPTION OF THE DRAWINGS

FIG. 1 is an explanatory diagram of parallel processing of ACC encoding processing of audio data and encryption processing of encoded audio data in an SoC that is an example of a data processing device in accordance with the present invention;

FIG. 2 is a flowchart describing a concrete flow of the parallel processing shown in FIG. 1;

FIG. 3 is another explanatory diagram of parallel processing of ACC encoding processing of audio data and encryption processing of encoded audio data in the SoC;

FIG. 4 is a flowchart describing a concrete flow of the parallel processing shown in FIG. 3;

FIG. 5 is a block diagram of an example of the overall configuration of the SoC; and

FIG. 6 is a block diagram of an example of a configuration of an accelerator core included in the SoC.

### DETAILED DESCRIPTION OF THE PREFERRED EMBODIMENTS

### 1. Typical Embodiment

To begin with, a typical embodiment of the present invention disclosed in the present application will be outlined below. Reference numerals in the drawings, which are referred to, written in parentheses in the description of the overview of the typical embodiment merely signify what are encompassed in the concepts of components to which the respective reference numerals are assigned.

[1] A data processing method in accordance with the typical embodiment of the present invention is such that: when a program of a first accelerator core (58) out of multiple accelerator cores (57, 58) is reconfigured for encryption processing in order to perform encryption processing on encoded data, a first general-purpose processor (52) out of multiple general-purpose processors (51, 52) controls an amount of encoded data so that the time required for encoding processing of data for one frame, and the total time of the program rewrite time for the first accelerator core and the time which the first accelerator core requires for implementing encryption processing of accumulated encoded data will be nearly equal to each other.

At a time point when an amount of encoded data exceeds a certain value, the program of the first accelerator core is rewritten and the first accelerator core is reconfigured in order to execute encryption processing. At this time, the other accelerator core performs encoding processing on the next frame. When the amount of encoded data is equal to or less than a certain value, the first accelerator core terminates the encryption processing and is rewritten again to a program for encoding processing.

According to the foregoing configuration, the time required for encoding processing of data for one frame and the total time of the program rewrite time for the first accelerator core and the time which the first accelerator core requires for implementing encryption processing of accumulated encoded data are nearly equal to each other. Accordingly, the wasted time during which hardware does not execute any operation can be minimized. Consequently, improvement in efficiency in a case where encoding processing of data and encryption processing are executed in parallel with each other can be achieved.

[2] Moreover, when multiple general-purpose processors are used to execute encoding processing of data and encryption processing of encoded data, the first general-purpose processor controls an amount of encoded data so that the time which the general-purpose processors require for respective pieces of encoding processing of data for one frame and the time which the first general-purpose processor out of the multiple general-purpose processors requires for implementing encryption processing of accumulated encoded data will be nearly equal to each other. Even in this case, since the wasted time during which hardware does not execute any operation can be minimized, improvement in efficiency in a case where encoding processing of data and encryption processing are executed in parallel with each other can be achieved.

[3] The control of an amount of encoded data may include a process in which: after an amount of data for one frame is calculated by each of the general-purpose processors, the general-purpose processors other than the first general-purpose processor are caused to transfer the respective amounts of frame data to a built-in memory (521) of the first general-purpose processor; and the first general-purpose processor (51) is caused to calculate the sum total of the amounts of data.

[4] The control of an amount of encoded data may include a process in which: after one frame is calculated by each of the general-purpose processors, the general-purpose processors are caused to transfer the respective amounts of frame data to a common memory (53) shared by the processors; and the first general-purpose processor (51) is caused to calculate the sum total of the amounts of data.

[5] The control of an amount of encoded data may include a process in which: after an amount of data for one frame is calculated by each of the general-purpose processors, the general-purpose processors are caused to transfer the respective amounts of frame data to an external memory (54) disposed outside a chip on which the processors are formed; and the first general-purpose processor (51) is caused to calculate the sum total of the amounts of data.

[6] A data processing device (50) in accordance with the typical embodiment of the present invention includes multiple general-purpose processors (51, 52), and multiple programmable accelerator cores (57, 58). The multiple accelerator cores include a first accelerator core (58) that has a program thereof reconfigured for encryption processing and rewritten to be able to execute encryption processing of encoded data. The multiple general-purpose processors include a first general-purpose processor (52) that, when the program of the first accelerator core is reconfigured for encryption processing in order to perform encryption processing on encoded data, controls an amount of encoded data so that the time required for encoding processing of data for one frame, and the total time of the program rewrite time for the first accelerator core and the time which the first accelerator core requires for implementing encryption processing of accumulated encoded data will be nearly equal to each other.

According to the foregoing configuration, the time required for encoding processing of data for one frame and the total time of the program rewrite time for the first accelerator core and the time which the first accelerator core requires for implementing encryption processing of accumulated encoded are nearly equal to each other. Consequently, since the wasted time during which hardware does not execute any operation can be minimized, improvement in efficiency in a case where encoding processing of data and encryption processing are executed in parallel with each other can be achieved.

[7] The first accelerator core includes a state transition management unit (601) that enables management of the internal state of the first accelerator core and control of a state transition on the basis of control information including configuration information that defines the logical function, and a configuration information management unit (602) that enables storage and transfer of the configuration information. In this case, the configuration information management unit and state transition management unit are used to reconfigure the program of the first accelerator core for encryption processing so as to perform encryption processing on encoded data.

### 2. Description of an Embodiment

Next, an embodiment will be described below.

In all drawings for use in explaining the embodiment, the same reference numerals will be in principle assigned to identical members. An iterative description will be omitted.

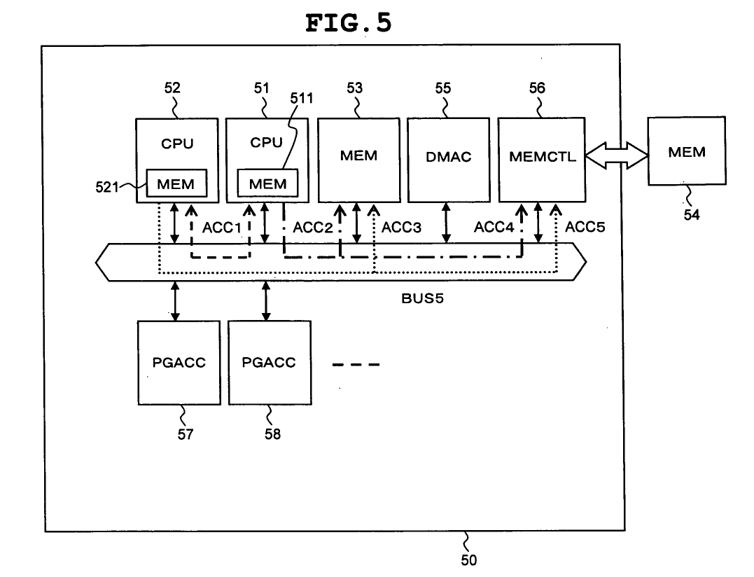

FIG. 5 shows an example of a configuration of a system on a chip (SoC) that is an example of a data processing device in accordance with the present invention.

An SoC 50 shown in FIG. 5 is coupled to an external memory (MEM) 54 over a system bus. The SoC 50 includes multiple intellectual properties (IP), though the IPs are not particularly limited to any specific ones. The SoC 50 is formed on one semiconductor substrate such as a silicon substrate according to a known semiconductor integrated circuit manufacturing technology. The multiple IPs include general-purpose processors (CPU) 51 and 52, accelerator cores (PGACC) 57 and 58, a direct memory access controller (DMAC) 55, a common memory (MEM) 53, and a memory controller (MEMCTL) 56, though they are not particularly limited to any specific ones. The general-purpose processors 51 and 52 have memories (MEM) 511 and 512 respectively incorporated therein. The multiple IPs are coupled to one another over a bus BUS5 so that they can transfer data to or from one another. The general-purpose processors 51 and 52 perform communication of frame-encoded data and control of an amount of data. As storage destinations of frame-encoded data, the memories 511 and 521 incorporated in the respective general-purpose processors 51 and 52, the common memory 53, and an external memory 54 are available. The accelerator cores 57 and 58 can be dynamically reconfigured according to a pre-set program and may be referred to as dynamically reconfigurable processors. The common memories (MEM) 53 and 54 each include a configuration information memory area. The general-purpose processor 51 sequentially executes CPU instructions stored in the common memories 53 and 54, and controls transfer of control information, which includes configuration information that defines the logical function of the accelerator core 57, and processed data.

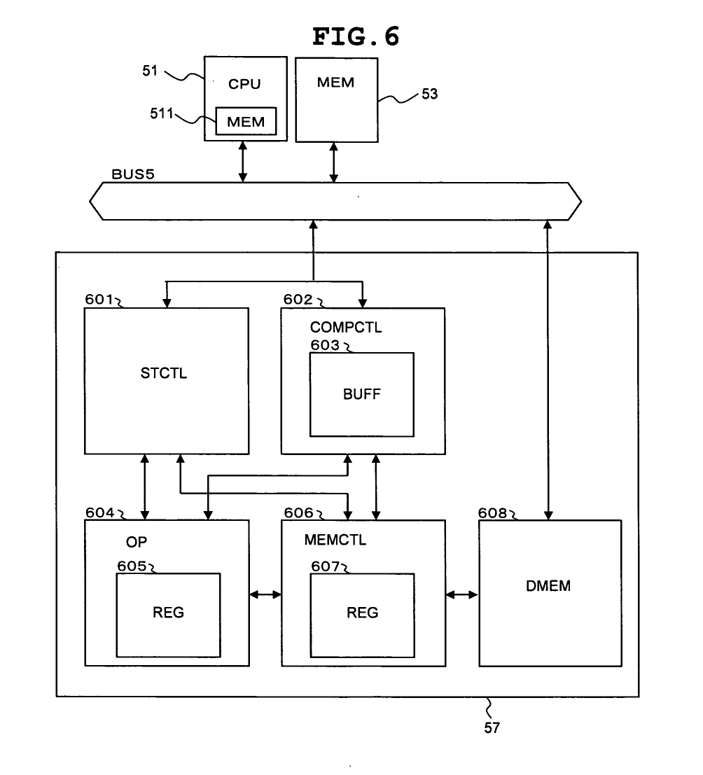

FIG. 6 shows an example of the configuration of the accelerator core (PGACC) 57.

The accelerator core 57 includes a state transition management unit (STCTL) 601, a configuration information management unit (COMPCTL) 602, an arithmetic and logic unit (OP) 604, a data memory control unit (MEMCTL) 606, and a data memory (DMEM) 608, though they are not particularly limited to any specific ones. The state transition management unit (601) is coupled to each of an external bus BUS5, the configuration information management unit 602, the arithmetic and logic unit 604, and the data memory control unit 606. The configuration information management unit 602 is coupled to each of the arithmetic and logic unit 604 and the data memory control unit 606. The arithmetic and logic unit 604 is coupled to the data memory control unit 606. The data memory control unit 606 is coupled to the data memory 608.

The state transition management unit 601 performs management of the internal state of the accelerator core 57 and control of a state transition on the basis of the control information. The configuration information management unit 602 includes a configuration information buffer (BUFF) 603, performs storage of configuration information, and controls transfer of configuration information to each of the arithmetic and logic unit 604 and data memory control unit 606. The arithmetic and logic unit 604 includes multiple arithmetic and logic blocks each including a configuration information register (REG) 605. The arithmetic and logic unit 604 performs storage and decoding of inputted configuration information, and executes an arithmetic and logic operation. The data memory control unit 606 includes multiple data memory control blocks each including a configuration information register 607, performs storage and decoding of inputted configuration information, and accesses the data memory 608.

In the foregoing configuration, the arithmetic and logic unit 604 stores configuration information in a specific bank in the configuration information register 605 on the basis of a writing request or writing destination register information inputted from the configuration information management unit 602. Further, based on a state transition request inputted from the state transition management unit 601, the arithmetic and logic unit 604 reads configuration information from a specific bank in the configuration information register 605, and determines a kind of arithmetic and logic operation and connection of an input or output to the data memory control unit 606 on the basis of the result of decoding. The configuration information register 605 is a register having a smaller capacity than the configuration information buffer 603 has, permits high-speed access, and can cope with a high-speed state transition. Moreover, when the configuration information register 605 has a multi-bank configuration, different banks can be designated as a writing destination bank and a reading source bank respectively in the case of transferring configuration information. Consequently, while configuration information is written from the configuration information management unit 602, an instruction can be read and decoded. Thus, the arithmetic and logic unit 604 can be efficiently utilized. The data memory control unit 606 stores configuration information in a specific bank in the configuration information register 607 on the basis of a writing request, a writing destination register, a writing destination bank number, and configuration information which are inputted from the configuration information management unit 602. Further, the data memory control unit 606 reads configuration information from a specific bank in the configuration information register 607 on the basis of a state transition request and a bank number which are inputted from the state transition management unit 601, and dynamically modifies the configuration thereof.

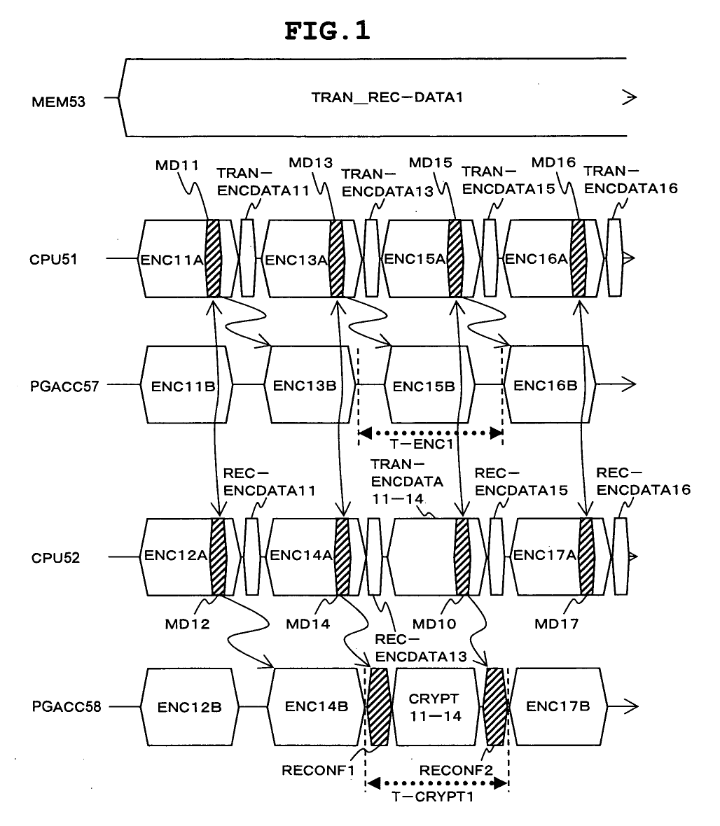

FIG. 1 shows fundamental synchronous points in parallel processing of ACC encoding processing of audio data and encryption processing of encoded audio data. In FIG. 1, the contents of pieces of processing by the major intellectual properties (IPs) of the SoC are drawn with blocks, control signals for synchronism are indicated with solid-line arrows, and times required for pieces of typical processing are indicated with dot-line arrows. The IPs include the common memory (MEM) 53, general-purpose processors (CPU) 51 and 52, and programmable accelerator cores (PGACC) 57 and 58. The pieces of processing include frame data transmission/reception processing TRAN_REC-DATA1, pieces of frame encoding processing ENC11A to ENC17B, pieces of encoded frame data transmission processing TRAN-ENCDATA11 to TRAN-ENCDATA16, pieces of encoded data reception processing REC-ENCDATA11 to REC-ENCDATA16, pieces of program rewrite processing RECONF1 and RECONF2, encryption processing CRYPT11-14, and pieces of amount-of-data control processing MD10 to MD17.

Incidentally, minute processes such as detail data transfer are omitted. For convenience' sake, a description will be made on the assumption that the pair of the accelerator core (PGACC) 57 and general-purpose processor (CPU) 51 implement encoding processing of preceding frame data, and the pair of the accelerator core (PGACC) 58 and general-purpose processor (CPU) 52 implement encoding processing of succeeding frame data. The order of execution of frame data items may be reversed or changed frame by frame.

Next, a flow of pieces of processing by the IPs will be described below.

To begin with, data for the first frame of audio data is transferred from the common memory (MEM) 53 to the accelerator core (PGACC) 57, and data for the second frame is transferred from the common memory (MEM) 53 to the accelerator core (PGACC) 58. Thereafter, encoding processing for the first frame is implemented by pairing the general-purpose processor (CPU) 51 and accelerator core (PGACC) 57, and encoding processing for the second frame is implemented by pairing the general-purpose processor (CPU) 52 and accelerator core (PGACC) 58. Part of the encoding processing for the first frame to be treated by the general-purpose processor (CPU) 51 is ENC11A, and part thereof to be treated by the accelerator core (PGACC) 57 is ENC11B. Part of the encoding processing for the second frame to be treated by the general-purpose processor (CPU) 52 is ENC12A, and part thereof to be treated by the accelerator core (PGACC) 58 is ENC12B.

At a time point when an amount of encoded frame data of the first frame is finalized, the general-purpose processor (CPU) 51 notifies the general-purpose processor (CPU) 52 of the amount of data (MD11). On the other hand, at a time point when an amount of encoded frame data of the second frame is finalized, the general-purpose processor (CPU) 52 notifies the general-purpose processor (CPU) 51 of the amount of data (MD12). At this time point, each of the general-purpose processors decides whether the amount of encoded frame data exceeds a certain value, and determines whether encryption processing should be implemented in parallel with encoding processing for the third frame, that is, whether the program of the accelerator core (PGACC) 58 should be rewritten. Herein, since the amount of accumulated encoded frame data is supposed not to exceed the certain value, it is determined that the encoding processing for the third frame will be implemented by the general-purpose processor (CPU) 51 and accelerator core (PGACC) 57 and that encoding processing for the fourth frame shall be implemented by the general-purpose processor (CPU) 52 and accelerator core (PGACC) 58. Thereafter, before the accelerator core (PGACC) 57 and a PGACC 12 initiate processing for the next frame, the common memory (MEM) 53 transfers necessary frame data to each of the accelerator cores. Meanwhile, after the encoding processing for the first frame is terminated, the general-purpose processor (CPU) 51 implements transmission processing TRAN-ENCDATA11 to the general-purpose processor (CPU) 52 for the encoded frame data. On the other hand, the general-purpose processor (CPU) 51 and accelerator core (PGACC) 57 initiate respective pieces of frame encoding processing ENC13A and ENC13B for the third frame. On the other hand, after the encoding processing for the second frame is terminated, the general-purpose processor (CPU) 52 implements reception processing REC-ENCDATA11 from the general-purpose processor (CPU) 51 for the encoded frame data for the first frame. Meanwhile, the general-purpose processor (CPU) 52 and accelerator core (PGACC) 58 initiate respective pieces of frame encoding processing ENC14A and ENC14b for the fourth frame.

Next, at a time point when an amount of encoded frame data for the third frame is finalized, the general-purpose processor (CPU) 51 notifies the general-purpose processor (CPU) 52 of the amount of encoded frame data (MD13). On the other hand, at a point when an amount of encoded frame data for the fourth frame is finalized, the general-purpose processor (CPU) 52 notifies the general-purpose processor (CPU) 51 of the amount of data (MD14). At this time point, similarly to the foregoing time point, each of the general-purpose processors decides whether the amount of encoded frame data exceeds a certain value, and determines whether the program of the accelerator core (PGACC) 58 should be rewritten. Herein, since the amount of accumulated encoded frame data is supposed to exceed the certain value, only the encoding processing for the fifth frame is determined to be implemented by the general-purpose processor (CPU) 51 and accelerator core (PGACC) 57. In contrast, encryption processing CRYPT11-14 is determined to be implemented by the accelerator core (PGACC) 58. In the accelerator core (PGACC) 58, program rewrite RECONF1 for encryption processing is initiated. Thereafter, before the accelerator core (PGACC) 57 initiates processing for the next frame, the common memory (MEM) 53 transfers necessary frame data to the accelerator core (PGACC) 57. Meanwhile, after the encoding processing for the third frame is terminated, the general-purpose processor (CPU) 51 implements transmission processing TRAN-ENCDATA13 to the general-purpose processor (CPU) 52 for the data. Meanwhile, the general-purpose processor (CPU) 51 and accelerator core (PGACC) 57 initiate respective pieces of frame encoding processing ENC15A and ENC15B for the fifth frame. On the other hand, after the encoding processing for the fourth frame is terminated, the general-purpose processor (CPU) 52 implements reception processing REC-ENCDATA13 from the general-purpose processor (CPU) 51 for the encoded data for the third frame. After problem rewrite by the accelerator core (PGACC) 58 is completed, the general-purpose processor (CPU) 52 initiates transfer processing TRAN-ENCDATA11-14 to the accelerator core (PGACC) 58 for the accumulated encoded data items for the first to fourth frames respectively.

Thereafter, at a time point when an amount of encoded frame data for the fifth frame is finalized, the general-purpose processor (CPU) 51 notifies the general-purpose processor (CPU) 52 of the amount of data (MD15). The general-purpose processor (CPU) 52 receives the notification signal for the amount of data (MD10), and proceeds with the transfer processing TRAN-ENCDATA11-14 to the accelerator core (PGACC) 58 until the accumulated encoded data gets equal to or smaller than a certain value. Herein, the reason why the transfer processing is executed until the accumulated encoded data gets equal to or smaller than the certain value is that there is generally a certain unit for an amount of data to be encrypted. When the accumulated encoded data gets equal to or smaller than the certain value, the general-purpose processor (CPU) 52 terminates the transfer of encoded data, and initiates rewrite RECONF2 to a program for encoding processing for the program of the accelerator core (PGACC) 58. In this case, it is automatically determined that encoding processing for the sixth frame will be implemented by the general-purpose processor (CPU) 51 and accelerator core (PGACC) 57 and that encoding processing for the seventh frame will be implemented by the general-purpose processor (CPU) 51 and accelerator core (PGACC) 58. Thereafter, before each of the accelerator cores (PGACC) 57 and PGAC 12 initiates processing for the next frame, the common memory (MEM) 53 transfers necessary frame data to each of the accelerators (PGACC) 57 and PGAC 12. Meanwhile, after the encoding processing for the fifth frame is terminated, the general-purpose processor (CPU) 51 implements transmission processing TRAN-ENCDATA15 to the general-purpose processor (CPU) 52 for the data. Meanwhile, the general-purpose processor (CPU) 51 and accelerator core (PGACC) 57 initiate respective pieces of frame encoding processing ENC16A and ENC16B for the sixth frame. On the other hand, the general-purpose processor (CPU) 52 initiates program rewrite for encoding processing. After reception processing REC-ENCDATA15 from the general-purpose processor (CPU) 51 for the encoded data for the fifth frame is completed, the general-purpose processor (CPU) 52 and accelerator core (PGACC) 58 initiate respective pieces of frame encoding processing ENC17A and ENC17B for the seventh frame. This is repeated as encoding processing for the subsequent frames.

In the foregoing parallel processing method, an amount of accumulated encoded data is controlled so that the time T-ENC1 calculated by adding the transmission processing time of encoded frame data to the encoding processing time of frame data will be nearly equal to the time T-CRYPT1 calculated by adding the program rewrite times RECONF1 and RECONF2 for the respective accelerator cores to the time required for encryption processing CRYPT11-14. Consequently, the IPs can be operated efficiently. Accordingly, high-speed processing can be executed.

In the example shown in FIG. 1, two general-purpose processors and two accelerator cores are employed. Alternatively, three or more general-purpose processors and three or more accelerator cores may be used to execute parallel processing. In this case, all the general-purpose processors that implement parallel processing notify themselves of amounts of encoded frame data. At a time point when an amount of accumulated encoded frame data exceeds a certain value, the program of one of the accelerator cores is rewritten for encryption, and encryption processing is executed. At this time, the time required for encoding processing for one frame and the total time of the time required for program rewrite for the accelerator core and the time required for encryption processing of accumulated encoded frame data are made nearly equal to each other similarly to the case of parallel processing employing two general-purpose processors and two accelerator cores.

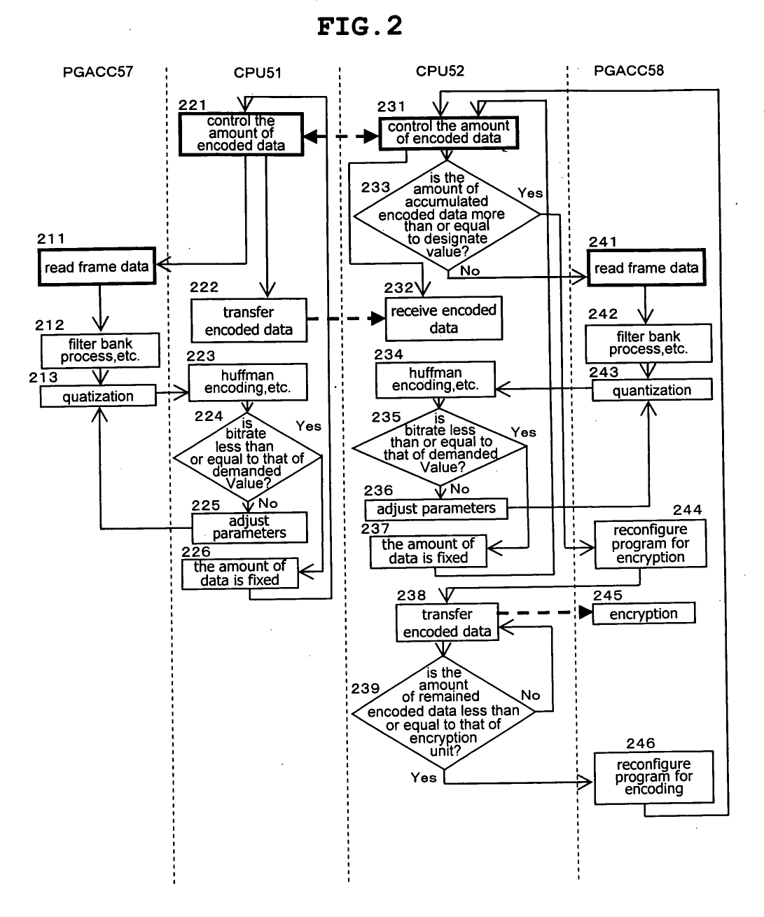

FIG. 2 concretely shows encoding processing of frame data according to the parallel processing method shown in FIG. 1.

Using FIG. 2, the contents of pieces of processing to be assigned to the accelerator cores (PGACC) 57 and 58 out of frame encoding processing, and amount-of-encoded frame data control processing will be described below.

Pieces of encoding processing for one frame are implemented in parallel with each other by employing an accelerator core PGACC and a general-purpose processor CPU as one pair. For convenience' sake, the pair of the accelerator core (PGACC) 57 and general-purpose processor (CPU) 51 shall implement encoding processing of preceding frame data, and the pair of the accelerator core (PGACC) 58 and general-purpose processor (CPU) 52 shall implement encoding processing of succeeding frame data. Incidentally, the order of frame data items may be reversed, or changed frame by frame. Herein, data for the first frame shall be read into the accelerator core (PGACC) 57, and data for the second frame shall be read into the accelerator core (PGACC) 58.

In encoding processing for one frame representative of the AAC or the like, frame data read processing (211, 241), Fourier transform processing (212, 242), quantization processing (213, 243), Huffman encoding processing (223, 234), bit rate decision processing (224, 235), parameter adjustment processing (225, 236), and amount-of-data fixing processing (226, 237) are implemented. The Fourier transform processing signifies a filter bank process or the like including a certain kind of fast Fourier transform. In FIG. 2, “filter bank process etc.” is merely written.

In this example, a general-purpose processor and an accelerator core are used to execute respective pieces of encoding processing in parallel with each other. Further, in order to efficiently execute encryption processing, amount-of-data control (221, 231), encoded data transfer (222), encoded data reception (232), amount-of-accumulated encoded data decision processing (233), program rewrite processing for encryption (244), encoded data transfer processing (238), encryption processing (245), amount-of-remaining encoded data decision processing (239), and program rewrite processing for encoding (246) are implemented.

Among the foregoing pieces of processing, loads of Fourier transform processing (212, 242), quantization processing (213, 243), Huffman encoding processing (223, 234), and encryption processing (245) are high. However, since the Fourier transform processing (212, 242), quantization processing (213, 243), and encryption processing (245) can be relatively readily speeded up using accelerator cores, if they are treated by the accelerator cores (PGACC) 57 and 58, it would be highly efficient. The general-purpose processors (CPU) 51 and 52 implement the other simple processing and control of the accelerator cores (PGACC) 57 and 58. Incidentally, the assignment of pieces of processing to the general-purpose processors (CPU) and accelerator cores is not limited to the above one but may be properly modified according to the loads by the respective pieces of processing and the processing abilities of the respective IPs. The general-purpose processor that controls the accelerator cores (PGACC) 57 and 58 may be any one other than the general-purpose processors (CPU) 51 and 52.

To begin with, the actions of the pair of the accelerator core (PGACC) 57 and general-purpose processor (CPU) 51 will be described below. The accelerator core (PGACC) 57 reads data for the first frame (211), and sequentially implements Fourier transform (212) and quantization (213). Thereafter, the general-purpose processor implements Huffman encoding etc. (223). Based on the result, bit rate value decision (224) is implemented. If a bit rate value is not equal to or smaller than a demanded value, parameter adjustment (225) is implemented. The accelerator core (PGACC) 57 re-executes pieces of processing succeeding quantization (213). On the other hand, if bit rate value decision (224) reveals that a bit rate value is equal to or smaller than the demanded value, an amount of frame-data encoded data is fixed (226). The amount of data is communicated to the general-purpose processor (CPU) 52 in order to control the amount of frame-data encoded data, and the frame to be processed next is determined (221). At this time, a storage destination for the amount of data may be the built-in memory 511 of either of the general-purpose processors (CPU) 51 and 52, the common memory 53 coupled to a bus, or the memory 54 coupled to the outside of the chip. Herein, since the pair of the accelerator core (PGACC) 58 and general-purpose processor (CPU) 52 processes the second frame, data for the third frame will be processed next. Thereafter, encoded data for the first frame is transferred (222). At this time, a storage destination for the data may be a built-in memory of either of the general-purpose processors (CPU) 51 and 52, the common memory coupled to a bus, or the memory coupled to the outside of the chip. Thereafter, the foregoing pieces of processing are repeated.

Next, the actions of the pair of the accelerator core (PGACC) 58 and general-purpose processor (CPU) 52 will be described below. The accelerator core (PGACC) 58 reads data for the second frame (241). The order of executing Fourier transform (242), quantization (243), Huffman encoding etc. (234), bit rate value decision (235), and parameter adjustment (236) is identical to the one followed by the pair of the accelerator core (PGACC) 57 and general-purpose processor (CPU) 52. If the result is equal to or smaller than a demanded bit rate, an amount of frame-date encoded data is fixed (237). The amount of data is communicated to the general-purpose processor (CPU) 51 in order to thus control the amount of frame-data encoded data (231). The encoded data for the first frame is transferred from the general-purpose processor (CPU) 51 to the memory 521 incorporated in the general-purpose processor (CPU) 52, the common memory 53 coupled to a bus, or the memory 54 outside the chip (232). At this time, if the amount of accumulated encoded data is equal to or less than a designate value, data for the fourth frame is read in order to initiate encoding processing (241, 242, 243, etc.). On the other hand, if the amount of accumulated encoded data exceeds the designate value, the program of the accelerator core (PGACC) 58 is rewritten for encryption processing (244). The encoded data accumulated in the general-purpose processor (CPU) 52 is transferred to the accelerator core (PGACC) 58 in units of data to be encrypted (238). The accelerator core (PGACC) 58 sequentially executes encryption (245). Meanwhile, whether an amount of remaining encoded data is equal to or less than an encryption unit is decided (239). If the amount is equal to or less than the encryption unit, the program of the accelerator core (PGACC) 58 is rewritten for encoding processing (246). During the time during which processing succeeding the program rewrite for encryption (244) is implemented, the pair of the accelerator core (PGACC) 57 and general-purpose processor (CPU) 51 completes encoding processing for the next frame. The amount of encoded data is received, combined with the amount of encoded data left with encryption, and controlled as a new amount of accumulated data having undergone encoding processing (231). Hereafter, the same pieces of processing as the above ones are repeated.

According to the foregoing example, an operation or an advantage described below can be provided.

A amount of accumulated encoded data is controlled so that the time required for encoding processing of audio data in units of a frame and the total time of the program rewrite time for a programmable accelerator core and the time required for encryption processing of encoded audio data will be nearly equal to each other. The timing of rewriting the program of the accelerator core for encryption processing is controlled. Since an amount of accumulated encoded data is thus controlled, hardware can be more efficiently operated than it can when encryption processing is implemented in units of a predetermined number of frames. The larger the numbers of mounted general-purpose processors and programmable accelerator cores are, the more outstanding performance improvement is.

Next, another example of processing will be described below.

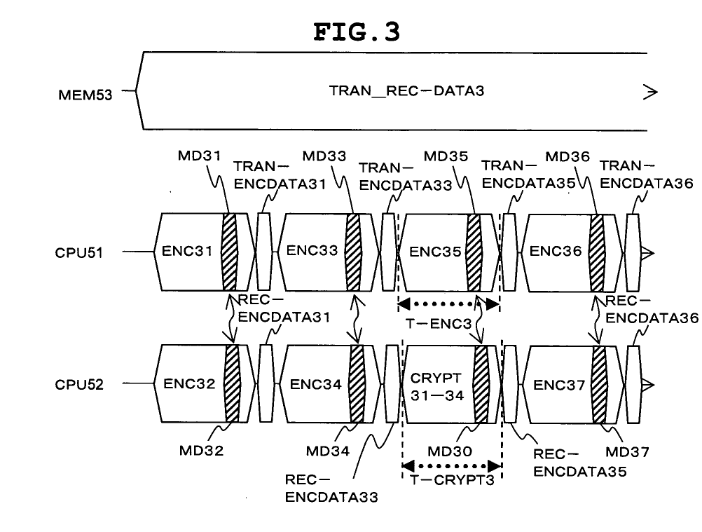

As long as multiple general-purpose processors are included in an SoC, high-speed parallel processing is possible without use of an accelerator core. FIG. 3 shows an example of parallel processing in such a case. Incidentally, in FIG. 3, the contents of pieces of processing by major IPs of the SoC are expressed with blocks, control signals for synchronism are indicated with arrows, and times required for the typical pieces of processing are indicated with dot-line arrows.

In the parallel processing shown in FIG. 3, the common memory (MEM) 53 and general-purpose processors (CPU) 51 and 52 which are shown in FIG. 5 and FIG. 6 are employed, but the accelerator cores 57 and 58 are left unemployed.

The contents of pieces of processing include frame data transmission/reception processing TRAN_REC-DATA3, pieces of frame encoding processing ENC31 to ENC37, pieces of encoded frame data transmission processing TRAN-ENCDATA31 to TRAN-ENCDATA36, pieces of encoded data reception processing REC_ENCDATA31 to REC-ENCDATA36, and encryption processing CRYPT31-34. Encoding processing to be implemented by each of the general-purpose processors (CPU) 51 and 52 includes amount-of-data control processing MAN-DATA. Incidentally, transfers of data and minute signals are omitted. For convenience' sake, a description will be made on the assumption that the pair of an accelerator core PGACC31 and the general-purpose processor (CPU) 51 implements encoding processing of preceding frame data and that the pair of an accelerator core PGACC32 and the general-purpose processor (CPU) 52 implements encoding processing of succeeding frame data. However, the order of frame data items may be reversed, or may be changed frame by frame.

Next, a flow of pieces of processing by the IPs will be described below.

To begin with, data for the first frame of audio data is transferred from the common memory (MEM) 53 to the general-purpose processor 31, and data for the second frame is transferred from the common memory (MEM) 53 to the general-purpose processor 32. Thereafter, frame encoding processing ENC31 for the first frame is implemented by the general-purpose processor (CPU) 51, and frame encoding processing ENC32 for the second frame is implemented by the general-purpose processor (CPU) 52.

At a time point when an amount of encoded frame data for the first frame is finalized, the general-purpose processor (CPU) 51 notifies the general-purpose processor (CPU) 52 of the amount of data (MAN-DATA out of ENC31). On the other hand, at a time point when an amount of encoded frame data for the second frame is finalized, the general-purpose processor (CPU) 52 notifies the general-purpose processor (CPU) 51 of the amount of data (MAN-DATA out of ENC32). At this time point, each of the general-purpose processors decides whether the amount of accumulated encoded frame data exceeds a certain value, and determines whether the general-purpose processor (CPU) 52 should implement encryption processing in parallel with encoding processing for the third frame. Herein, since the amount of encoded frame data is supposed not to exceed the certain value, it is determined that frame encoding processing ENC33 for the third frame is implemented by the general-purpose processor (CPU) 51 and that frame encoding processing ENC34 for the fourth frame is implemented by the general-purpose processor (CPU) 52. Thereafter, before each of the general-purpose processors (CPU) 51 and 52 initiates processing for the next frame, the common memory (MEM) 53 transfers necessary frame data to each of the general-purpose processors. Meanwhile, after the encoding processing for the first frame is terminated, the general-purpose processor (CPU) 51 implements transmission processing TRAN-ENCDATA31 to the general-purpose processor (CPU) 52 for the data. After the transmission processing is terminated, the general-purpose processor (CPU) 51 initiates frame encoding processing ENC33 for the third frame. On the other hand, after the encoding processing for the second frame is terminated, the general-purpose processor (CPU) 52 implements reception processing REC-ENCDATA31 from the general-purpose processor (CPU) 51 for the encoded data for the first frame. After the reception processing is terminated, the general-purpose processor (CPU) 52 initiates frame encoding processing ENC34 for the fourth frame.

Thereafter, at a time point when an amount of encoded frame data for the third frame is finalized, the general-purpose processor (CPU) 51 notifies the general-purpose processor (CPT) 52 of the amount of data (MAN-DATA out of ENC33). On the other hand, at a time point when an amount of encoded frame data for the fourth frame is finalized, the general-purpose processor (CPU) 52 notifies the general-purpose processor (CPU) 51 of the amount of data (MAN-DATA out of ENC34). At this time point, similarly to the aforesaid time point, each of the general-purpose processors decides whether the amount of encoded frame data exceeds a certain value, and determines whether the general-purpose processor (CPU) 52 should implement encryption processing in parallel with frame encoding processing ENC35 for the fifth frame. Herein, since the amount of accumulated encoded frame data is supposed to exceed the certain value, the general-purpose processor (CPU) 51 is determined to implement the frame encoding processing ENC35 for the fifth frame. On the other hand, the general-purpose processor (CPU) 52 is determined to implement encryption processing CRYPT31-34. Thereafter, before the general-purpose processor (CPU) 51 initiates processing for the next frame, the common memory (MEM) 53 transfers necessary frame data to the general-purpose processor 31. Meanwhile, after the frame encoding processing ENC33 for the third frame is terminated, the general-purpose processor (CPU) 51 implements transmission processing TRAN-ENCDATA33 to the general-purpose processor (CPU) 52 for the data. After the transmission processing is terminated, the general-purpose processor (CPU) 51 initiates the frame encoding processing ENC35 for the fifth frame. On the other hand, after the frame encoding processing ENC34 for the fourth frame is terminated, the general-purpose processor (CPU) 52 implements reception processing REC-ENCDATA33 from the general-purpose processor (CPU) 51 for the encoded data for the third frame. Thereafter, the general-purpose processor (CPU) 52 initiates encryption processing CRYPT31-34 for the accumulated encoded data items for the first to fourth frames respectively.

Thereafter, at a time point when an amount of encoded frame data for the fifth frame is finalized, the general-purpose processor (CPU) 51 notifies the general-purpose processor (CPU) 52 of the amount of data (MAN-DATA out of ENC35). The general-purpose processor (CPU) 52 receives the notification signal for the amount of data (MAN-DATA out of CRYPT31-34), and proceeds with the encryption processing CRYPT31-34 until accumulated encoded data gets equal to or smaller than a certain value. Herein, the reason why an effort is made not to allow the accumulated encoded data to get equal to or smaller than the certain value is that there is a minimum unit for data concerned at the time of encryption. When the accumulated encoded data gets equal to or smaller than the certain value, the general-purpose processor (CPU) 52 terminates encryption processing. In this case, it is automatically determined that encoding processing for the sixth frame is implemented by the general-purpose processor (CPU) 51 and that encoding processing for the seventh frame is implemented by the general-purpose processor (CPU) 52. Thereafter, before each of the general-purpose processors (CPU) 51 and 52 initiates processing for the next frame, the common memory (MEM) 53 transfers necessary frame data to each of the general-purpose CPUs 31 and 32. Meanwhile, after the encoding processing for the fifth frame is terminated, the general-purpose processor (CPU) 51 implements transmission processing TRAN-ENCDATA35 to the general-purpose processor (CPU) 52 for the data. After the transmission processing is terminated, the general-purpose processor (CPU) 51 initiates frame encoding processing ENC36 for the sixth frame. On the other hand, after the encryption processing CRYPT31-34 and reception processing REC-ENCDATA35 from the general-purpose processor (CPU) 51 for the encoded data for the fifth frame are completed, the general-purpose processor (CPU) 52 initiates the frame encoding processing ENC37 for the seventh frame. This is repeated as encoding processing for each of subsequent frames.

In the parallel processing method described above, an amount of accumulated encoded data is controlled so that the encoding processing time T-ENC3 for frame data and the time T-CRYPT3 required for encryption processing CRYPT31-34 will be nearly equal to each other. Consequently, the IPs are efficiently used and high-speed processing can be executed.

The detailed flowchart concerning frame data encoding processing for one frame is equivalent to a case where: processing implemented by the accelerator core (PGACC) 57 in FIG. 2 is treated by the general-purpose processor (CPU) 51; and processing implemented by the accelerator core (PGACC) 58 is treated by the general-purpose processor (CPU) 52.

Incidentally, in the example of FIG. 3, two general-purpose processors are employed. Alternatively, three or more general-purpose processors may be used to execute parallel processing. At this time, all the general-purpose processors that implement the parallel processing notify themselves of amounts of encoded frame data. At a time point when an amount of accumulated encoded frame data exceeds a certain value, one or more general-purpose processors execute encryption processing. In this case, a program of an accelerator core need not be rewritten. The time required for encoding processing for one frame and the time required for encryption processing of accumulated encoded frame data should merely be made nearly equal to each other.

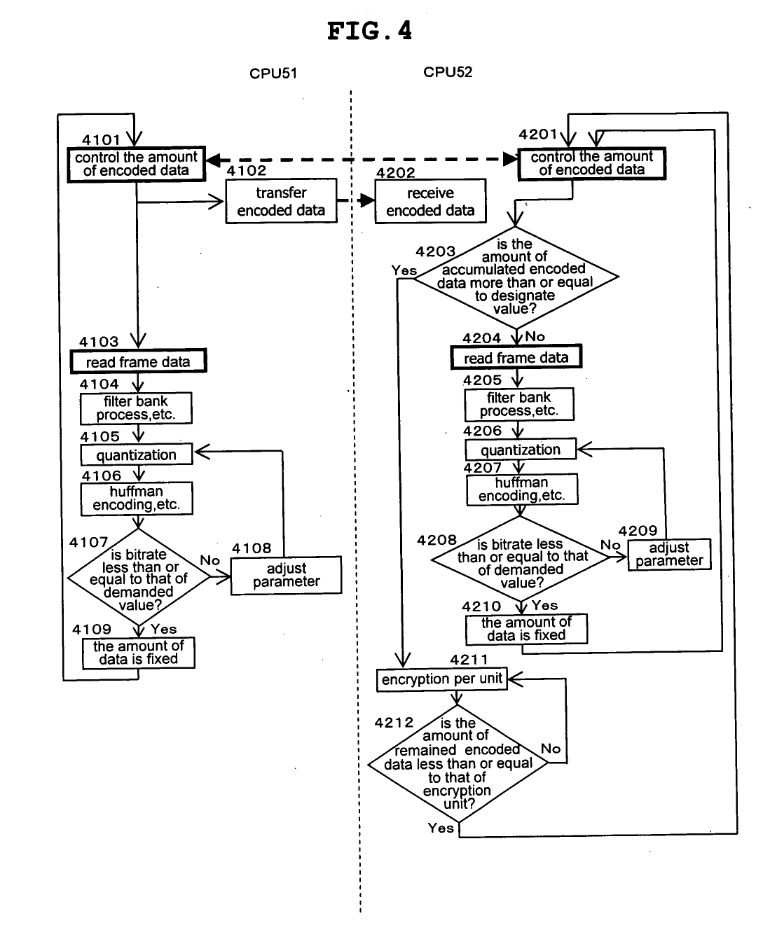

In FIG. 4, encoding processing of frame data according to the parallel processing method shown in FIG. 3 is concretely presented. Using the drawing, frame encoding processing and amount-of-encoded frame data control processing will be detailed below. As IPs for frame encoding processing, the general-purpose processors (CPUs) 51 and 52 are used. For convenience' sake, a description will be made on the assumption that the general-purpose processor (CPU) 51 implements encoding processing of preceding frame data, and the general-purpose processor (CPU) 52 implements encoding processing of succeeding frame data. However, the order of frame data items may be reversed, or may be changed frame by frame. Herein, data for the first frame shall be read into the general-purpose processor (CPU) 51, and data for the second frame shall be read into the general-purpose processor (CPU) 52.

To begin with, the action of the general-purpose processor (CPU) 51 will be described below. After the general-purpose processor (CPU) 51 sequentially implements data read for the first frame (4103), Fourier transform (4103), and quantization (4105), Huffman encoding processing etc. (4106) is implemented. The Fourier transform processing signifies a filter bank process or the like including a certain kind of fast Fourier transform. In FIG. 4, “filter bank process, etc.” is merely written. Based on the result, bit rate value decision (4107) is implemented. If a bit rate value is not equal to or smaller than a demanded value, parameter adjustment (4108) is implemented. The general-purpose processor (CPU) 51 continuously re-executes quantization (4105) and subsequent pieces of processing. On the other hand, if bit rate value decision (4107) reveals that a bit rate value is equal to or smaller than the demanded value, an amount of frame-data encoded data is fixed (4109), and the amount of data is communicated to the general-purpose processor (CPU) 52. Thus, an amount of frame-data encoded data is controlled, and a bit rate value for a frame to be processed next is determined (4101). At this time, a storage destination for the amount of data may be the built-in memory 511 or 521 of either of the general-purpose processors (CPUs) 51 and 52, the common memory 53 coupled to a bus, or the memory 54 coupled to the outside of the chip. Herein, since the general-purpose processor (CPU) 52 processes the second frame, the general-purpose processor (CPU) 51 processes data for the third frame next. Thereafter, the general-purpose processor (CPU) 51 transfers the encoded data for the first frame (4102). At this time, a storage destination for the amount of data may be the built-in memories 511 or 521 of either of the general-purpose processors (CPU) 51 and 52, the common memory 53 coupled to a bus, or the memory 54 coupled to the outside of the chip. Thereafter, the above pieces of processing are repeated.

Next, the action of the general-purpose processor (CPU) 52 pair will be described below. The order in which the general-purpose processor (CPU) 52 executes data read for the second frame (4204), Fourier transform (4205), quantization (4206), Huffman encoding etc. (4207), bit rate value decision (4208), and parameter adjustment (4209) is identical to that in which the general-purpose processor (CPU) 52 does. If the result is equal to or smaller than a demanded bit rate, an amount of frame-date encoded data is fixed (4210). The amount of data is communicated to the general-purpose processor (CPU) 51 in order to control an amount of frame-data encoded data (4201). At this time, a storage destination for the amount of data may be the built-in memory of either of the general-purpose processors (CPUs) 51 and 52, the common memory coupled to a bus, or the memory coupled to the outside of the chip. Thereafter, termination of transfer of the encoded data for the first frame produced by the general-purpose processor (CPU) 51 is confirmed (4202). At this time, if the sum total of amounts of accumulated encoded data is equal to or less than a designate value, data for the fourth frame is read and encoding processing is initiated. On the other hand, if the amounts of accumulated encoded data exceed the designate value, the general-purpose processor (CPU) 52 sequentially executes encryption (4211). Meanwhile, whether an amount of remaining encoded data gets equal to or less than an encryption unit is decided (4212). If it gets equal to or less than the encryption unit, a wait is held until the general-purpose processor (CPU) 51 terminates encoding processing for the next frame. After the general-purpose processor (CPU) 51 terminates encoding processing, the amount of encoded data is received, combined with the amount of encoded data left with encryption, and controlled as a new amount of accumulated data having undergone encoding processing (4201). At this time, a storage destination for the amount of data may be, similarly to the aforesaid case, the built-in memory 511 or 521 of either of the general-purpose processors (CPUs) 51 and 52, the common memory 53 coupled to a bus, or the memory 54 coupled to the outside of the chip. Thereafter, the same pieces of processing as those mentioned above are repeated.

As mentioned above, according to the foregoing example, IPs in an SoC can be efficiently used to perform at a high speed parallel processing of encoding processing and encryption processing or of pieces of encoding processing alone. When high-speed parallel processing is possible, if the power supply of any of the IPs having completed processing is discontinued or the operating frequency is lowered, while demanded performance is satisfied, low-power encoding processing and encryption processing or encoding processing alone can be executed.

The invention made by the present inventor has been concretely described. Needless to say, the present invention is not limited to the described embodiment, but can be modified in various manners without a departure from the gist.

In the aforesaid examples, audio data is adopted as an object of processing. Alternatively, video data or any other digital data may be adopted as an object of processing.

In the above description, a case where the invention made by the present inventor is applied to an SoC in a field of utilization that is the background of the invention has been described. The present invention is not limited to the SoC but can be widely adapted to various types of data processing devices.

What is claimed is:

1. A data processing method in which a plurality of general-purpose processors and a plurality of programmable accelerator cores are used to execute pieces of data encoding processing in parallel with each other,
wherein when a program of a first accelerator core out of the accelerator cores is reconfigured for encryption processing in order to perform encryption processing on encoded data, a first general-purpose processor out of the general-purpose processors controls an amount of encoded data so that a time required for encoding processing of data for one frame, and a total time of a program rewrite time for the first accelerator core and a time which the first accelerator core requires for implementing encryption processing of accumulated encoded data will be nearly equal to each other.

2. The data processing method wherein when the general-purpose processors are used to execute encoding processing of data and encryption processing of encoded data, the first general-purpose processor controls an amount of encoded data so that a time which the general-purpose processors require for respective pieces of encoding processing of data for one frame, and a time which the first general-purpose processor out of the general-purpose processors requires for implementing encryption processing of accumulated encoded data will be nearly equal to each other.

3. The data processing method according to claim 1, wherein the control of the amount of encoded data includes a process in which, after an amount of data for one frame is calculated by each of the general-purpose processors, the general-purpose processors other than the first general-purpose processor are caused to transfer the respective amounts of frame data to a built-in memory of the first general-purpose processor, and the first general-purpose processor is caused to calculate the sum total of the amounts of data.

4. The data processing method according to claim 1, wherein the control of the amount of encoded data includes a process in which, after an amount of data for one frame is calculated by each of the general-purpose processors, the general-purpose processors are caused to transfer the respective amounts of frame data to a common memory shared by the processors, and the first general-purpose processor is caused to calculate the sum total of the amounts of data.

5. The data processing method according to claim 1, wherein the control of the amount of encoded data includes a process in which, after an amount of data for one frame is calculated by each of the general-purpose processors, the general-purpose processors are caused to transfer the respective amounts of frame data to an external memory disposed outside a chip on which the plurality of general-purpose processors are formed, and the first general-purpose processor is caused to calculate the sum total of the amounts of data.

6. A data processing device comprising:
a plurality of general-purpose processors; and
a plurality of programmable accelerator core,
wherein the accelerator cores include a first accelerator core that has a program thereof reconfigured for encryption processing and rewritten to be able to execute encryption processing of encoded data, and
wherein the general-purpose processors include a first general-purpose processor for, when the program of the first accelerator core is reconfigured for encryption processing in order to perform encryption processing on encoded data, controlling an amount of encoded data so that a time required for encoding processing of data for one frame, and a total time of the program rewrite time for the first accelerator core and a time which the first accelerator core requires for implementing encryption processing of accumulated encoded data will be nearly equal to each other.

7. The data processing device according to claim 6,
wherein the first accelerator core includes a state transition management unit that enables management of an internal state of the first accelerator core and control of a state transition on the basis of control information including configuration information which defines a logical function, and a configuration information management unit that enables storage and transfer of the configuration information, and
wherein the configuration information management unit and the state transition management unit are used to reconfigure the program of the first accelerator core for encryption processing so as to enable encryption processing of encoded data.

8. The data processing device according to claim 6, wherein the first general-purpose processor includes a built-in memory to which, after an amount of data for one frame is calculated by each of the general-purpose processors, amounts of frame data are transferred from the respective general-purpose processors other than the first general-purpose processor, and calculates the sum total of the amounts of data in the built-in memory.

9. The data processing device according to claim 6, further comprising a common memory to which, after an amount of data for one frame is calculated by each of the general-purpose processors, amounts of frame audio data are transferred from the respective general-purpose processors,
wherein the first general-purpose processor calculates the sum total of the amounts of audio data in the common memory.

10. The data processing method according to claim 2, wherein the control of the amount of encoded data includes a process in which after an amount of data for one frame is calculated by each of the general-purpose processors, the general-purpose processors other than the first general-purpose processor are caused to transfer the respective amounts of frame data to a built-in memory of the first general-purpose processor, and the first general-purpose processor is caused to calculate the sum total of the amounts of data.

11. The data processing method according to claim 2, wherein the control of the amount of encoded data includes a process in which: after an amount of data for one frame is calculated by each of the general-purpose processors, the general-purpose processors are caused to transfer the respective amounts of frame data to a common memory shared by the processors; and the first general-purpose processor is caused to calculate the sum total of the amounts of data.

12. The data processing method according to claim 2, wherein the control of the amount of encoded data includes a process in which after an amount of data for one frame is calculated by each of the general-purpose processors, the general-purpose processors are caused to transfer the respective amounts of frame data to an external memory disposed outside a chip on which the processors are formed, and the first general-purpose processor is caused to calculate the sum total of the amounts of data.
